(19) United States
(12) Patent Application Publication
(10) Pub. No.: US 2026/0126788 A1
(43) Pub. Date: May 7, 2026

(54) METHODS, DEVICES, AND SYSTEMS FOR CREATING AND DISPLAYING SPATIAL HIERARCHY MODELS WITH AGGREGATED PERFORMANCE INDICATORS

(71) Applicant: Honeywell International Inc., Charlotte, NC (US)

(72) Inventors: VIJAY RAJU, Bengaluru (IN); ATUL DHAKA, Bengaluru (IN); AESHNA WARE, Bengaluru (IN); RAMESH A, Bangalore (IN); SHALU GUPTA, Bengaluru (IN); KARTHIKA M, Bangalore (IN)

(21) Appl. No.: 18/999,704

(22) Filed: Dec. 23, 2024

(30) Foreign Application Priority Data
Nov. 7, 2024 (IN) 202411085330

(51) Int. Cl. G05B 23/02

(52) U.S. Cl. CPC G05B 23/0283; G05B 23/0216

(57) ABSTRACT

An example method for spatial hierarchical model creation, display, and determination of aggregated performance indicators based on the spatial hierarchical model, the method comprising: receiving spatial hierarchy data defining a spatial hierarchical model of a plurality of levels of spaces in a building and one or more building control assets disposed within the plurality of levels of spaces, storing the spatial hierarchical model, displaying a visual representation of the spatial hierarchical model, mapping building equipment within the building to one or levels of spaces within the spatial hierarchical model, receiving, via the computing device, a selection of one or more spaces within the spatial hierarchical model; and responsive to receipt of the selection; displaying an aggregated performance indicator for the one or more spaces within the spatial hierarchical model.

### RELATED APPLICATIONS

This application claims the benefit of Indian Provisional Patent Application No. 202411083704, filed Nov. 1, 2024, which application is incorporated by reference herein.

### TECHNICAL FIELD

The present disclosure relates to systems, devices, and methods for aggregated performance indicators in spatial hierarchies, more specifically to creating and displaying spatial hierarchy models with aggregated performance indicators.

### BACKGROUND

Industrial process control and automation systems are often used to automate large and complex industrial processes. These types of systems routinely include sensors, actuators, and controllers. The controllers are often arranged hierarchically in a control and automation system. For example, lower-level controllers are often used to receive measurements from the sensors and perform process control operations to generate control signals for the actuators. Higher-level controllers are often used to perform higher-level functions, such as planning, scheduling, and optimization operations. Human process operators routinely interact with controllers and other devices in a control and automation system, such as to review warnings, alarms, or other notifications, and adjust control of or initiate performance of other operations (e.g., maintenance operations) to keep the process within desired process limits. If not properly managed, a building equipment issue such as a failure or malfunction of building equipment could escalate into an emergency, crisis, and/or disaster.

Moreover, it is desirable to monitor the health and functioning of various building equipment, for instance, via building management systems (BMS) systems to ensure optimal performance, ensure compliance with regulatory and/or manufacturing guidelines and/or achieve energy efficient goals in buildings. Some building management systems have evolved to incorporate complex spatial hierarchies and Internet of Things (IoT) technologies. These systems organize physical spaces within buildings into hierarchical structures, from broad levels like sites and towers down to specific rooms and zones. Some building management approaches leverage cloud-based platforms to collect, store, and analyze data from various sensors and equipment distributed throughout a building's spatial hierarchy. This integration of spatial modeling with IoT capabilities enables more efficient asset tracking, performance monitoring, and predictive maintenance in commercial and industrial facilities.

### SUMMARY

The present disclosure relates generally to systems, devices, and methods for creating and displaying spatial hierarchy models with aggregated performance indicators. The systems, devices, and methods can thereby yield enhanced analytics (e.g., contextualization), prediction, and remediation (e.g., autocorrection) of building equipment issues (e.g., as determined based on the aggregated performance indicators) such as those related to an industrial process control and automation system.

For instance, the systems, devices, and methods herein can facilitate creating and managing a spatial hierarchical model that is suitable for building management. The systems, devices, and methods herein permit receiving and storing spatial hierarchy data, creating and displaying a spatial hierarchy model based on the spatial hierarchy data. Such a display provides a framework for organizing and analyzing building control assets within a spatial context (e.g., permits users to select and view specific levels within the hierarchy and associated performance data). The systems, devices, and methods herein permit determining attributes (e.g., corresponding to individual building equipment and aggregated performance indicators for levels (e.g., spaces) within a spatial hierarchy, mapping building equipment and attributes to spaces, and presenting aggregated performance indicators for one or more spaces. For instance, the systems, devices, and methods herein allow users to interact with the spatial hierarchy model through a display interface, select levels and view associated information and performance attributes of the spaces, and/or customize the levels and information associated therewith. In some instances, the system, devices and methods permit display aggregated performance indicators based on actual equipment data associated with one or more specific levels of the spatial hierarchy when the one or more specific levels are selected (e.g., via an input to a display of a computing device, etc.).

The systems, devices, and methods herein facilitate the definition of spatial hierarchies encompassing various levels of spaces, ranging from country, region, and city down to floor plans, rooms, and smaller spatial units. Users can access and modify the hierarchy through an intuitive user interface (UI), enabling seamless management of space types and usage. These defined spaces serve as a framework for mapping assets, facilitating data collection, and conducting analytics within IoT environments. An example, spatial hierarchy building management system can include a user interface of human machine interface that displays a hierarchical structure of spaces, starting from “Site” at the top level and including multiple levels (e.g., Site>Tower>Floor>Zone>Room). That is, spatial hierarchies encompass various levels of spaces, ranging from country, region, and city down to floor plans, rooms, and smaller spatial units. As detailed herein, each level within the spatial hierarchy can have corresponding information. For instance, a level or space (e.g., conference room) within the spatial hierarchy can be selected (e.g., via a user input to the UI) and corresponding information (e.g., Name, Space Type, Description, Space Usage Type, Arca, Occupancy, and Priority can be displayed). This feature permits readily mapping assets, facilitating data collection, and conducting analytics within IoT environments.

In short, the disclosure principally relates to a user interface providing key features relating to the formation of spatial hierarchies that allow a user to readily visualize and configure spatial elements within one or more sites, thereby permitting enhanced building management and operations based at least on the use of the spatial hierarchies (e.g., in conjunction with a BMS). For instance, the spatial hierarchies herein can be utilized to yield enhanced (e.g., quicker and/or more accurate) building equipment issue prediction and hence can lead to improved building equipment issue remediation. Moreover, use of the spatial hierarchies can lead to a reduction in onboarding time for predictive maintenance offerings (e.g., which are configured to identify a future occurrence of a building equipment issue and initiate remediation of the building equipment issue prior to an actual occurrence of the predicted building equipment issue).

Notably, in some embodiments aggregated performance indicators (e.g., KPIs) for one or more zones and/or one or more rooms within the zones can be determined and displayed. In some embodiments, aggregated KPIs (e.g., overall comfort, zones out of temperature range, etc.) can be determined for zones (e.g., including one or more rooms) within a site. Similarly, aggregated KPIs can be determined for individual rooms within the zone. Hence, the systems, devices, and methods herein can permit a higher-level view of the performance of portions of a site, as compared to some approaches that may permit determination of KPIs only on a building equipment (e.g., individual building equipment level). Determination of aggregated KPIs e.g., for a zone or room may be particularly desirable to ensure the actual environment functions as intended (e.g., regardless of the specific performance of one or more building equipment located therein). For instance, it may be desirable to ensure that room remains within a comfortable temperature range for occupants of the room and/or that a manufacturing facility (e.g., a pharmaceutical manufacturing facility) remains within an acceptable temperature range (e.g., less than 22 degrees Celsius) to ensure that the product remains viable/complies with any regulations (e.g., FDA regulations) associated with manufacture of the product.

At least in view of the above, the system, devices, and methods herein, can mitigate downtime, repair/replacement costs, and/or any impact on tenants or occupants of buildings, as compared to other approaches such as those that rely solely on reactive maintenance or rely solely on performance data of individual building equipment.

As used herein, a building equipment issue refers to a malfunction or breakdown of systems or devices that are integral to the operation and maintenance of a building's infrastructure such as those that are monitored by a building management system (BMS). Examples of building equipment include heating, ventilation, and air conditioning (HVAC) systems (e.g., including cooling towers, chillers, etc.), lighting systems, security and surveillance systems, fire safety systems, plumbing and water systems, energy management systems, and transportation systems (e.g., escalators, elevators, etc.), among others. Examples of building equipment issues include an HVAC failure such as when a heating or cooling system stops functioning, resulting in uncomfortable or unsafe temperature conditions, an electrical failure such as when a power supply to lighting or security systems is interrupted, a sensor malfunction such as when a temperature, humidity, and/or occupancy sensors may fail to provide accurate data (e.g., leading to improper system responses), and/or an energy equipment failure such as a failure of a solar panels or energy storage system (e.g., leading to inefficient energy use). However, embodiments of the present disclosure are not limited to these examples. The building equipment issues may occur at a site. For instance, a site can be a single building or facility, a plurality (e.g., group) of buildings, an area (e.g., room(s), space(s), zone(s), etc.) within a building or facility, or a campus of an organization. Embodiments of the present disclosure are not limited to these examples.

A particular example of the present disclosure includes an illustrative method for spatial hierarchy model creation, display, and determination of aggregated performance indicators based on the spatial hierarchical model, where the spatial hierarchal model provides spatial context to a plurality of building control assets disposed within a plurality of hierarchical levels of spaces in the spatial hierarchical model, the method comprising: receiving, by a computing device of a building management system, spatial hierarchy data defining a spatial hierarchical model of a plurality of levels of spaces in a building and one or more building control assets disposed in the plurality of levels of spaces; storing the spatial hierarchical model; displaying, via a user interface, a visual representation of the spatial hierarchical model; mapping building equipment within the building to one or levels of spaces within the spatial hierarchical model; receiving, via the computing device, a selection of one or more spaces within the spatial hierarchical model; and responsive to receipt of the selection; displaying an aggregated performance indicator for the one or more spaces within the spatial hierarchical model, wherein the aggregated performance indicator is based on actual building equipment performance data of building equipment that is mapped to the one or more spaces within the spatial hierarchical model.

Another example of the present disclosure includes a computing device for spatial hierarchy model creation, display, and determination of aggregated performance indicators based on the spatial hierarchical model, where the spatial hierarchal model provides spatial context to a plurality of building control assets disposed in a plurality of hierarchical levels of spaces in the spatial hierarchical model, the computing device comprising: a display; a memory; and a processor configured to execute executable non-transitory computer readable instructions stored in the memory to: receive, via inputs provided to the display, spatial hierarchy data defining a spatial hierarchical model of a plurality of levels of spaces within a building and one or more building control assets disposed within the plurality of levels of spaces; store the spatial hierarchical model in a database; display, via the display, a visual representation of the spatial hierarchical model; map building equipment within the building to one or more spaces within the spatial hierarchical model; receive, via the display, a selection of one or more spaces within the spatial hierarchical model; and responsive to receipt of the selection, display, via the display aggregated performance indicator for the one or more spaces within the spatial hierarchical model, wherein the aggregated performance indicator is based on actual building equipment performance data of building equipment that is mapped to the one or more spaces within the spatial hierarchical model.

Another example of the present disclosure includes a non-transitory, computer-readable medium including instructions that when executed by a processor cause the processor to: receive, via inputs provided to a display, spatial hierarchy data defining a spatial hierarchical model of a plurality of spaces within levels of a building and one or more building control assets disposed in the plurality spaces; determine a priority, a space type, an occupancy state, or any combination thereof associated with each of the one or more spaces in the spatial hierarchical model; store the spatial hierarchical model in a database; display, via the display, a visual representation of the spatial hierarchical model; map, based on inputs provided to the display, building equipment within the building to the spaces within the spatial hierarchical model; display, via the display, indications of each of the levels of the spaces in the spatial hierarchical model; receive, via the display, a selection of an indication of one or more spaces within the displayed spatial hierarchical model; and responsive to receipt of the selection, display, via the display: a priority, a space type, an occupancy state, or any combination thereof associated with each of the one or more selected spaces in in the spatial hierarchy; and aggregated performance indicator for the one or more spaces within the spatial hierarchical model, wherein the aggregated performance indicator is based on actual building equipment performance data of building equipment that is mapped to the one or more selected spaces within the spatial hierarchical model.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram of an illustrative industrial process control and automation system;

FIG. 2 is an example computing device for creating and displaying spatial hierarchy models with aggregated performance indicators;

FIG. 3 is an example of a user interface for creating and displaying spatial hierarchy models with aggregated performance indicators;

FIG. 4 is an example of a user interface for displaying aggregated performance indicators in spatial hierarchy models;

FIG. 5 is another example of an illustrative building equipment hierarchy for creating and displaying spatial hierarchy models with aggregated performance indicators;

FIG. 6 illustrates a user interface for displaying categorized aggregated performance of building equipment in one or more spaces in a spatial hierarchy model; and

FIG. 7 is a flow diagram showing an illustrative method for creating and displaying spatial hierarchy models with aggregated performance indicators.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which similar elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic is described in connection with an embodiment, it is contemplated that the feature, structure, or characteristic may be applied to other embodiments whether or not explicitly described unless clearly stated to the contrary.

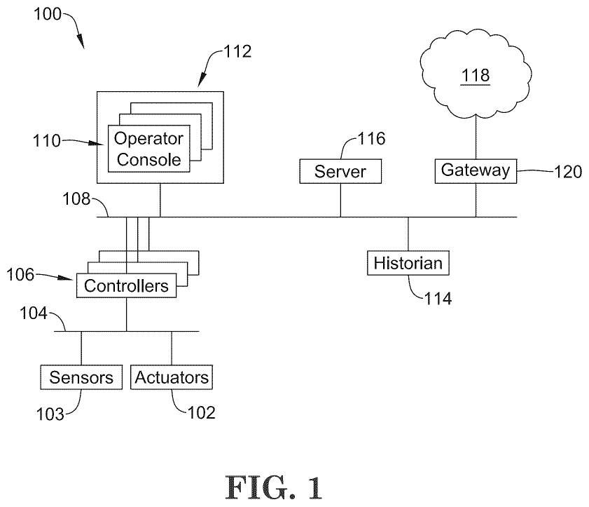

FIG. 1 provides a schematic block diagram showing an illustrative industrial process control and automation system 100. The system 100 includes various components that facilitate production or processing of at least one product or other material. For instance, the system 100 can be used to facilitate control over components in one or multiple industrial plants. The industrial plants may be one or more processing facilities (or one or more portions thereof), such as one or more manufacturing facilities for producing at least one product or other material. In general, the industrial plants may implement one or more industrial processes and can individually or collectively be referred to as a process system. A process system generally represents any system or portion thereof configured to process one or more products or other materials in some manner.

The system 100 includes one or more sensors 103 and one or more actuators 102. The sensors 103 and the actuators 102 represent components in a process system that may perform any of a wide variety of functions. In certain embodiments, sensors 103 and actuators 102 can correspond to equipment that is controlled by the automation system. That is, the sensors 103 and actuators 102 represent components in the industrial plant that perform any of a wide variety of functions. For example, sensors and actuators can measure various characteristics of the process system as well as alter any number of characteristics in the process system of the industrial plant represented by the system 100. The sensors 103 and actuators 102 can be automatically controlled by the process system of the industrial plant (e.g., to permit autocorrection of building equipment issues, as detailed herein), manually controlled, or a combination thereof. The control and manipulation of the sensors 103 by the personnel or the process system of the industrial plant, or the combination thereof can be recorded by the historian, discussed in further detail below. For example, each time the sensors 103 and actuators 102 are adjusted, a record is created within the historian. The sensors 103 may measure a wide variety of characteristics in the process system, such as but not limited to temperature, pressure, flow rate, chemical concentrations, or a voltage transmitted through an electrical conductor. The actuators 102 may represent devices that are configured to alter a wide variety of characteristics in the process system. As an example, the actuators 102 may open or close one or more valves, or increase or decrease a process set point or the like. At any rate, each sensor 103 may include any suitable structure for measuring one or more characteristics in a process system. Each actuator 102 may include any suitable structure for operating on or affecting one or more conditions of a process system.

In the example shown, a network 104 is coupled to the sensors 103 and the actuators 102. The network 104 facilitates interaction with the sensors 103 and the actuator 102. For example, the network 104 may transmit measurement data from the sensors 103 and/or may provide control signals to the actuator 102. The network 104 may represent any suitable network or combination of networks. As particular examples, the network 104 could represent at least one Ethernet network (such as one supporting a FOUNDATION FIELDBUS protocol), electrical signal network (such as a HART network), Ethernet network, pneumatic control signal network, or any other or additional type(s) of network(s), or any other type of communication path.

The illustrative system 100 also includes various controllers 106. The controllers 106 may, for example, be used in the system 100 to perform various functions in order to control one or more industrial processes. To illustrate, a first set of controllers 106 may use measurements from one or more of the sensors 103 to control the operation of one or more of the actuators 102. A controller 18 may receive measurement data from one or more sensors 103 and use the measurement data to generate control signals for one or more actuators 102. A second set of controllers 106 may be used to optimize the control logic or other operations performed by the first set of controllers. A third set of controllers, 106, could be used to perform additional functions. The controllers 106 could therefore support a combination of approaches, such as regulatory control, advanced regulatory control, supervisory control, and advanced process control.

Each of the controllers 106 may include any suitable structure for controlling one or more aspects of an industrial process. At least some of the controllers 106 may, for example, represent proportional-integral-derivative (PID) controllers or multivariable controllers, such as controllers implementing model predictive control (MPC) or other advanced predictive control (APC). As a particular example, each controller of the controllers 106 may represent a computing device running a real-time operating system, a WINDOWS operating system, or other operating system.

In the illustrative system 100, at least one network 108 couples to the controllers 106 and the other devices in the system 100. The network 108 facilitates communication of information between components. The network 108 may represent any suitable network or combination of networks. For example, the network 108 could represent an Ethernet network or any other suitable communication path.

Operator access to and interaction with the controllers 106 and other components of the system 100 can occur via various operator consoles 110. Each operator console 110 may be used to provide information to an operator and receive information from an operator. For example, each operator console 110 may provide information identifying a current state of an industrial process to the operator, such as values of various process variables and warnings, alarms, or other states associated with the industrial process. Each operator console of the operator consoles 110 may also receive information affecting how the industrial process is controlled, such as by receiving set points or control modes for process variables controlled by the controllers 106 or other information that alters or affects how the controllers 106 control the industrial process. Each operator console 110 may include any suitable structure for displaying information to and interacting with an operator. For example, each operator console 110 may represent a computing device running a WINDOWS operating system or other operating system. In some embodiments, the operator console 110 can be configured to display the user interfaces e.g., dashboards described herein. Alternatively or additionally, the user interfaces e.g., dashboards described herein can be displayed elsewhere, for instance, at a console associated with a supervisor or other personal associated with the industrial plant.

Multiple operator consoles 110 may be grouped together and used in one or more control rooms 112. Each control room 112 may include any number of operator consoles 110 in any suitable arrangement. In some cases, multiple control rooms 112 may be used to control an industrial plant, such as when each control room 112 contains operator consoles 110 used to manage a discrete part of the industrial process/plant.

The illustrative system 100 also includes one or more servers 116. Each server 116 denotes a computing device that executes applications for users of the operator consoles 110 or other applications. The applications could be used to support various functions for the operator consoles 110, the controllers 106, or other components of the system 100. The servers 116 may be located locally or remotely from the illustrative system 100. For instance, the functionality of the server 116 could be implemented in a computing cloud or a remote server communicatively coupled to the system 100 via a gateway such as gateway 120. Each server 116 may represent a computing device running a WINDOWS operating system or other operating system. Note that while shown as being local within the system 100, the functionality of the server 116 may be remote from the system 100. For instance, the functionality of the server 116 may be implemented in a cloud-based server 118 or a remote server communicatively coupled to the system 100 via the gateway 120.

The control and automation system 100 here also includes at least one historian 114. The historian 114 represents a component that stores various information about the system 100. The historian 114 could, for instance, store information that is generated by the various controllers and/or various operators, etc. during the control of one or more industrial processes. The historian 114 includes any suitable structure for storing and facilitating retrieval of information such as a volatile and/or non-volatile memory. Although shown as a single component here, the historian 114 could be located elsewhere in the system 100, or multiple historians could be distributed in different locations in the system 100.

Although FIG. 1 shows one example of the industrial process control and automation system 100, it will be appreciated that various changes may be made. For example, the control and automation system 100 may include any number of sensors, actuators, controllers, servers, networks, operator stations, operator consoles, control rooms, networks, and other components. Also, the makeup and arrangement of the system 100 in FIG. 1 is for illustration only. Components may be added, omitted, combined, further subdivided, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates one example operational environment of an industrial plant where system operations done by the various personnel can be monitored. This functionality can be used in any other suitable system, and that system need not be used for industrial process control and automation.

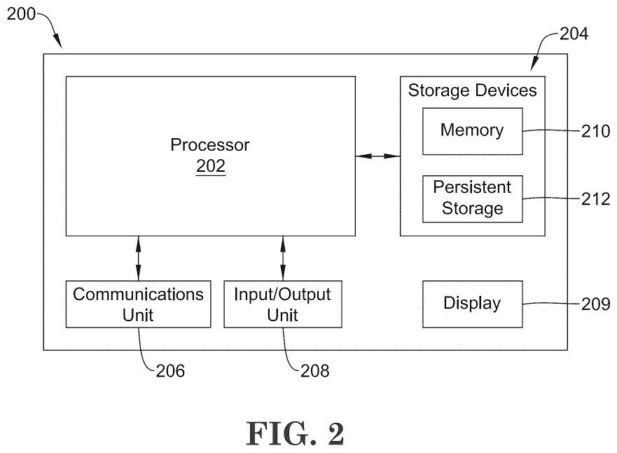

FIG. 2 illustrates an example computing device for creating and displaying spatial hierarchy models with aggregated performance indicators. In particular, FIG. 2 illustrates an example computing device 200. In some embodiments, the computing device 200 could denote an operator station, server, a remote server or device, or a mobile device. The computing device 200 could be used to run applications. The computing device 200 could be used to perform one or more functions, such as collecting information, sorting and analyzing the information as well as generating a report of the analysis, generating a spatial hierarchy model, as described herein, and/or initiating remediation (e.g., initiating an autocorrection and/or manual remediation) of an identified building equipment issue (e.g., an occurrence of a future building equipment issue for a future time period, etc.) that is identified based on display or analysis of the spatial hierarchy model and/or aggregated performance indicators associated with the spatial hierarchy model, as described herein. For case of explanation, and the computing device 200 are described as being used in the system 100 of FIG. 1, although the computing device 200 could be used in any other suitable system (whether or not related to industrial process control and automation).

As shown in FIG. 2, the computing device 200 includes at least one processor 202, at least one storage device 204, at least one communications unit 206, and at least one input/output (I/O) unit 208. Each processor 202 can execute instructions, such as those that may be loaded into a memory 210. Each processor 202 denotes any suitable processing device, such as one or more microprocessors, microcontrollers, digital signal processors, application specific integrated circuits (ASICs), field programmable gate arrays (FPGAs), or discrete circuitry.

The memory 210 and a persistent storage 212 are examples of storage devices 204, which represent any structure(s) configured to store and facilitate retrieval of information (such as data, program code, and/or other suitable information on a temporary or permanent basis). The memory 210 may represent a random-access memory or any other suitable volatile or non-volatile storage device(s). The persistent storage 212 may contain one or more components or devices supporting longer-term storage of data, such as a read-only memory, hard drive, flash memory, or optical disc.

The communications unit 206 supports communications with other systems or devices. For example, the communications unit 206 could include at least one network interface card or wireless transceiver facilitating communications over at least one wired or wireless network (such as a local intranet or a public network like the Internet). The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display such as a display 209, printer, or other suitable output device.

The display 209 allows at least output of data. In some instances, the display 209 corresponds to a monitor. In some embodiments, the display 209 corresponds to a touch screen display that allows input and output of data.

Although FIG. 2 illustrates example computing device 200 capable of facilitating or otherwise performing at least some aspects of build equipment issue prediction, tracking, analytics, and/or building equipment issue remediation may be made to FIG. 2. For example, various components in FIG. 2 could be combined, further subdivided, or omitted, and additional components could be added according to particular needs. As a particular example, processor 202 can be divided into multiple processors (e.g., hardware processors), such as one or more central processing units (CPUs) and one or more graphics processing units (GPUs). Also, computing device 200 can come in a wide variety of configurations, and FIG. 2 does not limit this disclosure to any particular computing device or mobile device.

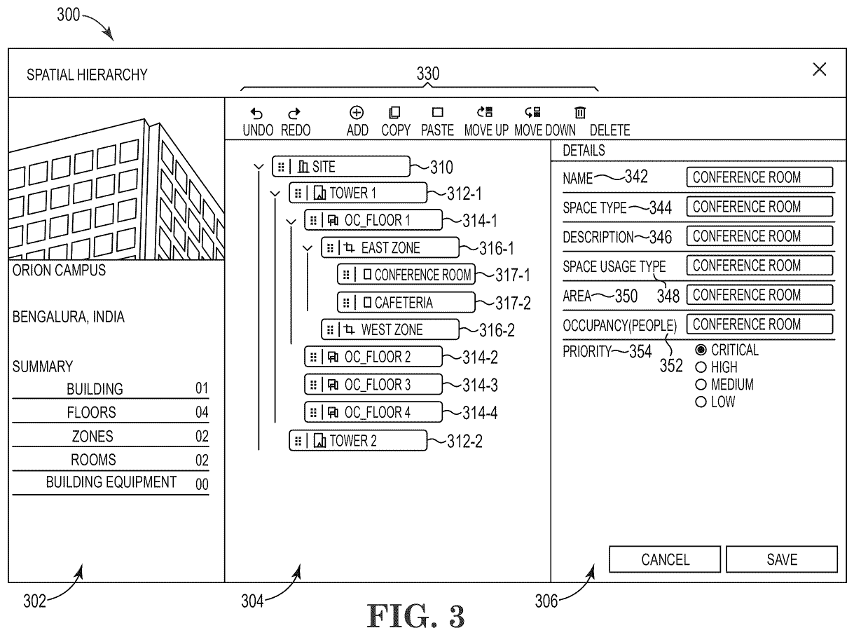

FIG. 3 is an example of a user interface 300 for creating and displaying spatial hierarchy models with aggregated performance indicators. The user interface 300 can be included in or displayed by a computing device such as the computing device 200. As illustrated in FIG. 3, a summary 302 of elements (e.g., spaces and/or building equipment) in a spatial hierarchy model 304 can be displayed along with display the spatial hierarchy model 304. Additionally, detailed information 306 associated with one or more spaces in the spatial hierarchy model 304, can be displayed via the user interface 300. For example, the summary 302 of elements (e.g., spaces and/or building equipment) in the spatial hierarchy model 304 can be displayed. The summary 302 can include respective counts of a quantity of buildings (e.g., 1 building) in the spatial hierarchal model 304, a quantity of floors (e.g., 4 floors) in the spatial hierarchal model 304, a quantity of zones (e.g., 2 zones) in the spatial hierarchal model 304, a quantity of rooms (e.g., 2 rooms) in the spatial hierarchy model 304, and a quantity of building equipment (e.g., 0 building equipment) that is mapped to the spaces in the spatial hierarchy model 304. The summary 302 can be specific to one or more locations or campuses (e.g., an Orion campus, as illustrated in FIG. 2) and can display identifying information (e.g., name, geographic location, etc.) associated with the one or more locations or campuses. The summary 302 can be specific to each of the elements included in the spatial hierarchy model 304 or can be specific to one or more selected spaces (e.g., a conference room) in the spatial hierarchy model 304.

The spatial hierarchy model 304 can be generated (e.g., based on spatial hierarchy data and/or one or more user inputs to the display 300). The user interface or display 300 provides options for a user to readily create and/or modify the spatial hierarchy model. For instance, the user interface can be configured with various graphical elements (e.g., Undo, Redo, Add, Copy, Paste, move up, move down, and delete, etc.), permitting users to modify the spatial hierarchy, thereby providing seamless management of space types and usage. For example, a user can provide an input via one or more selectable icons or graphical elements 320 that are displayed in the user interface 300. Selection of such selectable icons or graphical elements 320 can permit a user to readily create or modify aspects of the spatial hierarchy model 304. Examples of such selectable icons or graphical elements 320 include an undo icon, a redo icon, an add icon (e.g., to add one or more spaces), a copy icon (e.g., to copy one or mor spaces within the spatial hierarchy model 304, a paste icon, a move up icon (e.g., to move a space up to another level within the spatial hierarchy model), a move down icon (e.g., to move a space down to another level within the spatial hierarchy model 304, and/or a delete icon (e.g., to delete a space within the spatial hierarchy 304), among other types of icons.

As mentioned, the spatial hierarchy model 304 can be used to organize and monitor various assets within a facility or across multiple facilities. For example, the spatial hierarchy model 304 can include a particular site or building 310 having various levels therein. As illustrated in FIG. 3 the site 310 can include two towers 312-1, 312-2. The towers 312-1, 312-2 can include various levels therein. For instance, the levels within a first town 312-1 can be displayed responsive to selection of a dropdown menu or other icon. The first tower 312-1 can include a plurality (e.g., four) floors 314-1, 314-2, 314-3, 314-4. A first floor 314-1 can include a plurality of zones (e.g., an cast zone and a west zone) 316-1, 316-2 therein. Each zone can include one or more rooms. For instance, a first zone 316-1 can include a plurality of rooms 317-1, 317-2 therein.

The user interface 300 can be configured as illustrated in FIG. 3 to permit a user to readily visualize the spatial context and interrelation of some or all of the spaces in the spatial hierarchy model 304. Additionally, the user interface 300 can configured to permit a user to select one or more spaces in the spatial hierarchy 304. Once selected, the color or other indication of the selection can be displayed via the user interface 300. For example, as illustrated in FIG. 3, a room (e.g., the cafeteria) is selected and thus the graphical icon representative of the selected room is a different color than the other unselected spaces (e.g., other rooms) within the spatial hierarchy model 304. Hence, an indication of a respective location of the selected one or more levels within the spatial hierarchical model can be displayed responsive to receipt of the selection (e.g., an input to the user interface 300) of the one or more levels in the displayed spatial hierarchical model 304.

Responsive to the selection of one or more spaces in the displayed spatial hierarchical model 304, detailed information 306 associated with the one or more selected spaces can be displayed via the user interface 300. For example, the detailed information 306 can include a name, a space type, a description, a space usage type, an area or size, an occupancy state (e.g., an actual occupancy state or a designed occupancy state), and/or a priority (e.g., low priority, medium priority, high priority, or critical priority). For instance, as illustrated in FIG. 3, the detailed information 306 associated with the selected space (e.g., the conference room 317-2) can be displayed. Continuing with this example, the detailed information 306 can be manifested as a name 342 (e.g., Conference Room), a space type 344 (e.g., room), a description 346 (e.g., board meeting), a space usage type 348 (e.g., business), an area 350 (e.g., 300 square/feet), an occupancy 352 (e.g., a designed or actual occupancy of 10 people), and a priority 354 (e.g., critical priority) associated with the selected space (e.g., conference room 317-2).

While the spatial hierarchy model 304 in FIG. 3 includes a particular quantity of elements (e.g., zones, rooms, etc.) alternate elements and/or different quantities of elements can be included in the spatial hierarchy models herein. Alternatively or in addition, while the spatial hierarchy model 304 has an absence of building equipment mapped thereto, in some embodiments building equipment can be mapped to one or more of the spaces in the spatial hierarchies herein.

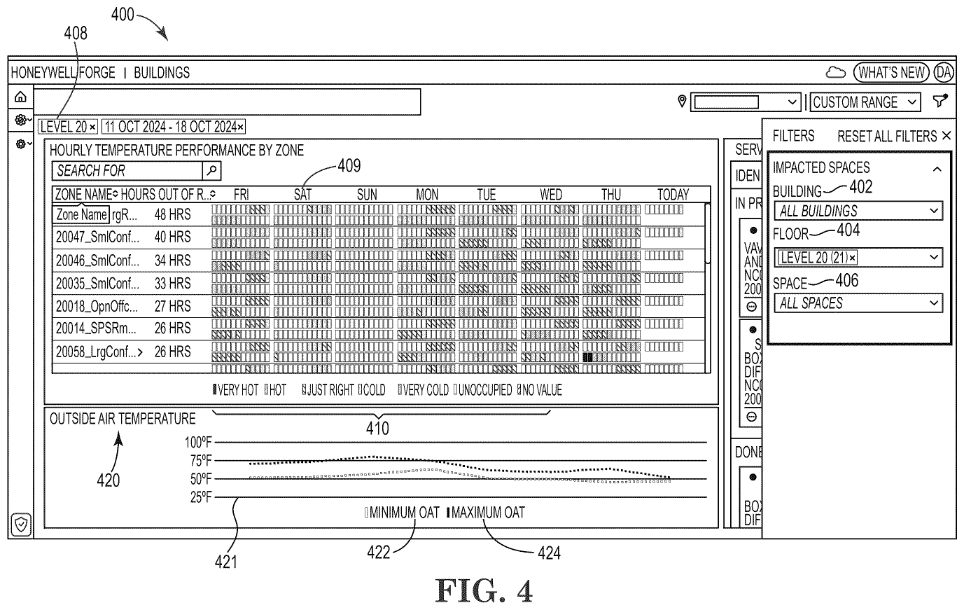

For example, FIG. 4 illustrates an embodiment with building equipment mapped to zones within a floor (e.g., floor 20) of a spatial hierarchy model. That is, FIG. 4 illustrates an example of a user interface for displaying aggregated performance indicators in spatial hierarchy models. As illustrated in FIG. 4, the systems, devices, and methods herein permit a user to easily drill down or otherwise ascertain various information associated with one or more selected spaces within the spatial hierarchy model. For instance, FIG. 4 pertains to a particular floor 404 (e.g., floor 20 which is selected via dropdown menu) with one or more buildings 402 (e.g., all buildings which are selected via a dropdown menus) in a spatial hierarchy model. In such instances, one or more spaces 406 (e.g., zones) within the selected floor (e.g., floor 20) can be selected. For example, as illustrated in FIG. 4 all spaces (e.g., all zones within floor 20) can be selected as indicated at 406 e.g., via a dropdown menu. Hence, the approaches herein allow a user to readily view various performance information (e.g., as displayed in the collection of graphical elements 409) associated with one or more selected spaces in a spatial hierarchy model. Continuing with the above example, performance information such as aggregated performance indicator associated with the selected spaces (e.g., each of zones in floor 20), as indicated at 408. In this example, the temperature performance (e.g., hourly temperature performance) of the respective zones can be displayed via the user interface 400. For example, as indicated in FIG. 400 the user interface 400 can display icons (e.g., respective blocks pertaining to various temperature performance) of the zones. The blocks can be differently colored blocks, shaded blocks, or otherwise be configured to convey temperature performance of the zones. For instance, the blocks can be differently shaded or marked to indicate temperature performance of the zones (e.g., on any hourly basis, etc.) over a period of time. As indicated in FIG. 4, the blocks can correspond to various temperature performances levels such as those indicated at 409 (e.g., very hot, hot, just right, cold, very cold, or no data) and/or can indicate an occupancy state of the spaces (e.g., unoccupied, occupied). As mentioned, the different blocks can be compared (e.g., by a user or automatically by a computing device) to one or more performance thresholds. Hence, the approaches herein can readily ascertain the presence of any current building equipment issues associated with the spaces and can also predict e.g., based on comparison of the actual performance to performance threshold occurrences of future building equipment issues, as detailed herein.

In addition to displaying the actual aggregated performance indicators (e.g., actual temperature performance of one or more spaces), the user interface 400 can be configured to display various environmental conditions such as those that may impact actual performance (e.g., temperature performance, humidity performance, etc.) of the spaces and/or building equipment mapped to the spaces. For example, as illustrated in FIG. 4, an outside air temperature 420 can be displayed as graph 421 which displays various outside air temperature information such as a low temperature 422 and/or a high temperature 424. The concurrent display of the actual aggregated performance indicators for one or more spaces along with the information (e.g., outside air temperature, outside humidity, etc.) that may impact the actual aggregated performance indicators can provide user and/or computing devices with additional context with regard to the actual aggregated performance indicators. Such additional context may assist in discerning whether any potential building equipment issues are merely transient issues (e.g., associated with a high outside temperature) or building equipment issues that may persist (e.g., and thus may need to be remediated).

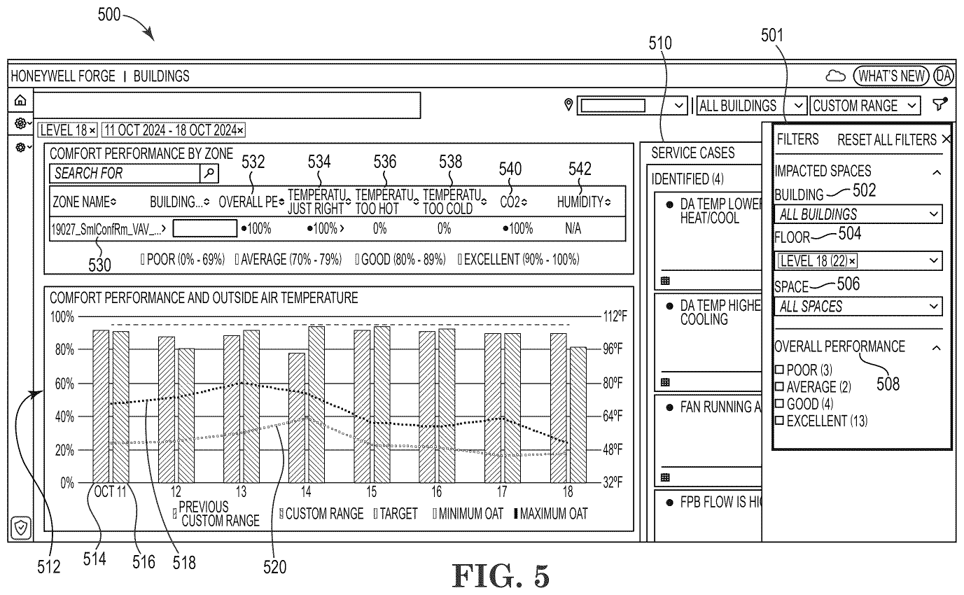

For example, FIG. 5 is a user interface configured to concurrently display actual aggregated performance indicators (e.g., actual aggregated temperature performance of building equipment in one or more zones) along with real-world environmental information (e.g., an outside temperature) that may impact the actual aggregated performance of the spaces. Similar to FIG. 4, the user interface 500 in FIG. 5 pertains to a particular floor 504 (e.g., floor 18 which is selected via dropdown menu) with one or more buildings 502 (e.g., all buildings which are selected via a dropdown menus) in a spatial hierarchy model. In such instances, one or more spaces 506 (e.g., zones) within the selected floor (e.g., floor 18) can be selected. For example, as illustrated in FIG. 5 all spaces (e.g., all zones within floor 18) can be selected as indicated at 506 e.g., via a dropdown menu.

A summary for one or more sites can be provided via the user interface. Examples of summary information include a summary of added elements (e.g., 1 building, 4 floors, 2 zones, 2 rooms, and/or various types of building equipment, etc.) and/or location (e.g., country/city information) associated with one or more sites. Thus, the systems, devices and methods herein can permit on-going tracking and categorization of various spatial elements within one or more sites. For instance, as illustrated in FIG. 5, a summary of the overall performance 508 can be displayed for some or all of the building equipment mapped to the selected space(s). The overall performance 508 can include categories such as poor, average, good, and excellent and can include a quantity of building equipment in the space in each respective category, as illustrated in FIG. 5.

As illustrated at 512, a graphical representation of actual aggregated performance of the selected space and corresponding environmental conditions (e.g., outside temperatures) can be displayed. For instance, the prior performance 514 of the building equipment and the current performance 516 of the building equipment mapped to the space can be displayed as respective bars in a bar graph over a period of time (e.g., days, months, etc.). The environmental conditions (e.g., a low outside temperature 520 and a high outside temperature 518) can be displayed, for instance, as trend lines that are overlaid on the bar graph, as illustrated in FIG. 5.

As illustrated at 530, one or more aggregated performance indicators can be displayed for the selected zone. For example, an overall aggregated performance indicator 532 can be displayed. The overall aggregated performance indicator can be equal to an average or weighted average of individual performance indicators. Examples of individual performance indicators include a temperature just right indicator 534, a temperature too hot indicator 536, a temperature too cold indicator 538, a carbon dioxide indicator (CO2) indicator 540, and/or a humidity indictor 542, as illustrated in FIG. 5. These are merely examples and other performance indicators can be employed in addition to or as an alternative to the performance indicators illustrated in FIG. 5.

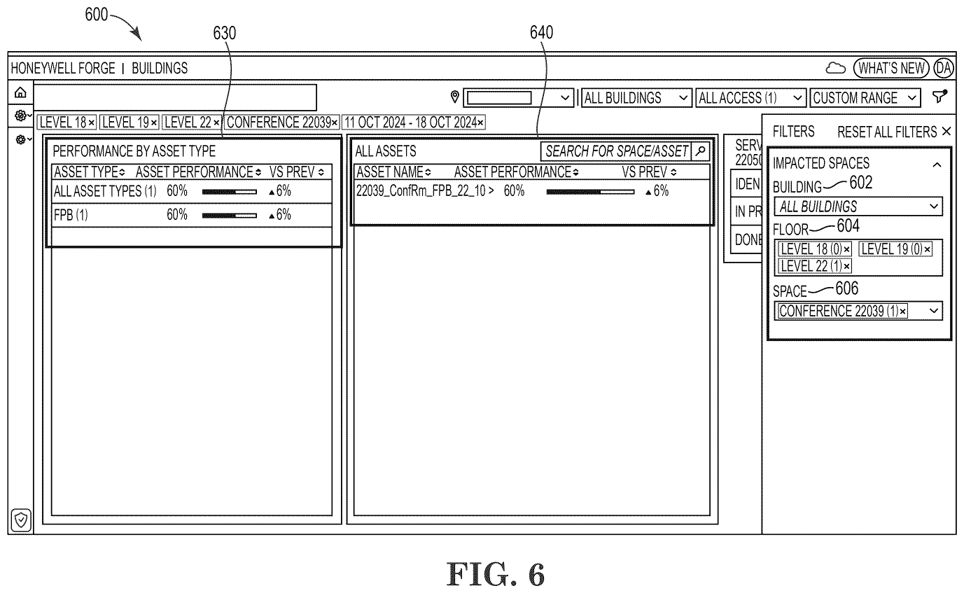

In some embodiments, aggregated performance of building equipment can be categorized, for instance, based on a type of building equipment. For example, FIG. 6 illustrates a user interface 600 displaying categorized aggregated performance of building equipment in one or more spaces in a spatial hierarchy model. Similar to FIGS. 4-5, the user interface 600 in FIG. 6 pertains to one or more particular floors 604 (e.g., floors 18, 19 and 22) with one or more buildings 602 (e.g., all buildings which are selected via a dropdown menus) in a spatial hierarchy model. In such instances, one or more spaces 606 (e.g., rooms) within the selected floors can be selected. For example, as illustrated in FIG. 6 an individual room (e.g., a conference room) can be selected as indicated at 606.

The aggregated performance of all building equipment in the selected individual building room can be displayed. For example, the aggregated performance by asset type 630 can be displayed via the user interface 600, as illustrated in FIG. 6. For example, one or more of the assets in a selected space that are of a selected asset type (e.g., field programmable board (FPB) can be displayed. An actual aggregated performance (e.g., an actual aggregated performance that is equal to 60%) of the one or more assets in the selected asset type can be displayed. In some embodiments, the actual aggregated performance (e.g., a current performance) of the one or more assets of a particular asset type can be displayed concurrently with a previous aggregated performance (e.g., 6%) of the same assets at an earlier time period. This concurrent display can aid in determination and/or prediction of the presence of building equipment issues (e.g., by comparing current asset performance to the previous asset performance). In some embodiments, the one or more assets of the particular asset type, as displayed at 630, can be displayed concurrently with all assets, as illustrated at 640, in the selected space.

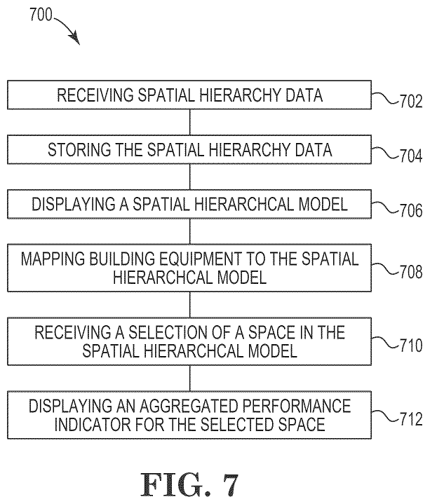

FIG. 7 is a flow diagram showing an illustrative method 700 for creating and displaying spatial hierarchy models with aggregated performance indicators. At 702, the method 700 includes receiving, by a computing device (e.g., computing device 200 as described with respect to FIG. 2) of a building management system, actual performance and operating condition data associated with building equipment at a site (e.g., managed by the BMS) for a time period. The actual performance and operating condition data can be received continuously, periodically (e.g., each minute, each hour, etc.), and/or can be received responsive to an input (e.g., responsive to an input by a site supervisor to a computing device such as the computing device 200, as described with respect to FIG. 2).

The method 700 can include receiving spatial hierarchy data defining a spatial hierarchical model of a plurality of levels of spaces within a building and one or more building control assets in the plurality of levels of spaces, as indicated at 702. For instance, the spatial hierarchy data can be received based on inputs (e.g., manual inputs) provided via a display of a computing device and/or can be based on various data, received at 702, such as BMS data. For example, a user interface of a computing device can include controls (e.g., selectable icons displayed via the user interface) that are configured for adding, copying, pasting, moving, and deleting elements of the spatial hierarchical model and/or adding, deleting, and/or altering associations of building equipment with one or more spaces in the spatial hierarchical model. In some embodiments, the spatial hierarchy data can be representative of an actual physical arrangement or hierarchy of a plurality of levels of spaces within a building and one or more building control assets located in the plurality of levels of spaces in the building. The spatial hierarchy data can be utilized to create a spatial hierarchy model, as detailed herein.

In some embodiments, the method 700 can include receiving, via the user interface, detailed information for a selected space, the detailed information including at least one of: space type, description, space usage type, area, occupancy, and/or a priority of the selected space. Examples of space types include rooms, hallways, conference rooms, floors, zones including one or more rooms, buildings including one or more zones, etc. Examples of descriptions of space include a description of a location, a size, and/or other information associated with the space. Examples of space usage include manufacturing, research, meeting rooms, cafeteria areas, etc. Examples of occupancy include a designed occupancy (e.g., a maximum occupancy) and/or an actual occupancy (e.g., a past, current and/or anticipated future occupancy state). Examples of priorities include low priority spaces (e.g., vacant rooms), medium priority spaces (e.g., conference rooms or individual office spaces), and high priority areas (e.g., manufacturing spaces), among other types of priorities. Each of the spaces can have corresponding detailed information. For instance, a first space (e.g., a first room) can have a different space usage type, area, occupancy, and/or a priority than a space usage type, area, occupancy, and/or a priority of another space in the spatial hierarchical model. In some embodiments, the detailed information can be provided at the same time the space is created (or modified) or at a subsequent time to creation and/or modification of a space within the spatial hierarchy. In some embodiments, at least some of the spaces within the spatial hierarchy can have corresponding detailed information. In some embodiments, each of the spaces within the spatial hierarchy can have corresponding detailed information.

A spatial hierarchy model can be generated based on the spatial hierarchy data. For instance, a spatial hierarchy of one or more buildings can be generated. Each of the spatial hierarchies can include levels of spaces therein. The levels of spaces can include at two or more of: a tower or other sub-structure within an overall building or complex, one or more floors within the tower or other sub-structure of the building, one or more zones within the one or more floors, and one or more rooms within the one or more zones, as detailed herein. These are merely examples and other types of spaces within a building may be employed. The spatial hierarchy can be created by one or more of the computing devices described herein. For instance, a computing device can be configured to automatically create the spatial hierarchy responsive to receipt of the spatial hierarchy data.

At 704, the method 700 can include storing the spatial hierarchical model. For instance, the spatial hierarchical model can be stored in a database or other type of storage structure. For instance, the spatial hierarchical model and/or information pertaining thereto such as an aggregated performance indicator of one or more levels in the spatial hierarchical model and/or a mapping of building equipment to the one or more levels, etc. can be stored in a centralized platform, such as ENTERPRISE BUILDINGS INTEGRATOR™ and/or FORGE; available from HONEYWELL™, Inc.

At 706, the method 700 includes displaying a representation of the spatial hierarchal model, as described herein. At 708, the method 700 includes mapping building equipment within the building to one or levels of spaces within the spatial hierarchical model. The mapping of building equipment can occur automatically (e.g., during and/or subsequent to installation and/or on-boarding of building equipment, for instance, based on BMS data, etc.) and/or can rely on manual inputs provided to a computing device, such as those described herein. For instance, in some examples the building equipment located at a site (e.g., in a building) can be initially mapped automatically (e.g., based on BMS data) and can, in some instances, be manually edited (e.g., via the removal or addition of building equipment associated with one or more levels in a spatial hierarchical model. For example, the method 700 can include receiving, via the user interface of computing device, modifications to the spatial hierarchical model, modifications to the mapped building equipment, or both. Responsive to receipt of such an input for a modification, the modified spatial hierarchical model, the modified mapped building equipment, or both can be stored and can be displayed (e.g., a visual representation of one or both of the modified spatial hierarchical model and the modified building equipment mapping can be displayed). Hence, the systems, devices, and methods herein provide an initiative and efficient mechanism (e.g., via dragging and dropping or otherwise selecting graphical elements in a user interface) to readily modify the spatial hierarchical model, the mapped building equipment that is mapped to one or more level in the spatial hierarchical model, or both.

Building equipment that is mapped to a space can include at least the building equipment that is physically located within the space. For instance, each individual instance of building equipment that has associated BMS data or other performance data that is physically located within a space can be mapped to the space. In some embodiments, additional building equipment that is physically located outside of the space can also be mapped to the space. For instance, an air handling unit of other type of building equipment that is located upstream or above the building equipment (e.g., a valve or damper) that is actually located in the space can be mapped to the space. Hence, the aggregated building performance information that is generated for the space, as detailed herein, can be based at least on the respective building equipment performance information of building equipment that is physically located within a space (e.g., an individual space or level in the spatial hierarchical model). Yet, in some instance, the aggregated building equipment performance information can additionally be based on respective building equipment performance information for building equipment in spatial hierarchical model that is located upstream or above (e.g., in the same system such as an HVAC system) the building equipment physically located in the space. In some embodiments, the method comprises generating the aggregated performance indicator for an individual space (e.g., an individual zone or an individual room, etc.) within the spatial hierarchical model.

In some embodiments, the method 700 can include generating the aggregated performance indicator for one or more spaces within the spatial hierarchical model. As used herein, an aggregated performance indicator (e.g., a comfort indicator) refers to a numerical and/or other type of indicator (e.g., numeric value, percentage, and/or time range) of how well the building equipment that is mapped to a space within a spatial hierarchal model is performing. For instance, an aggregated performance indicator can be associated with various building equipment in a heating, ventilation, and air conditioning (HVAC) system that is mapped to a space in a spatial hierarchal model. The aggregated performance indicator can be configured to indicate or permit determination of whether the compilation of building equipment in the space (and hence the space) is maintaining a desired performance/comfort levels (such as temperature, humidity, and/or air quality) in the space.

For instance, the aggregated performance indicator for a respective space can be equal to or based on respective performance indicators associated with building equipment mapped to the space in the spatial hierarchical model. For example, an aggregated performance indicator for a respective space can be equal to an average or weighted average of respective performance indicators associated with each individual building equipment component (e.g., a pump, a heat exchanger, a fan, an occupancy sensor, an air handling unit, a cooling tower, a chiller, a refrigerator or freezer, etc.) building equipment that is mapped to the space in the spatial hierarchical model. Additionally, in some embodiments, the aggregated performance indicator for a space can be at least partially based on performance data associated with building equipment that is located upstream or above building equipment in the space in the spatial hierarchical model.

In some embodiments, the aggregated performance indicator can include an in-range performance indicator of the one or more zones for a time period, an out-of-range performance indicator of the one or more zones for the time period, or both. That is, the aggregated performance indicator can indicate an amount of time over a given time period that the one or more zones are operating within and/or are operating outside a desired operating range. Moreover, in some embodiments, the aggregated performance indicator can be configured to quantify a degree of deviation, if any, from the desired operating range of the one or more spaces in a spatial hierarchical model of a building.

For example, an overall performance indicator can be a numerical value or other type of indicator (e.g., a check mark, etc.) that indicates that the building equipment mapped to a space satisfied a performance threshold for a time period. For instance, the overall performance indicator can include an actual low value (e.g., low temperature, low humidity, etc.), an average value (e.g., an average temperature, average humidity, etc.) and/or a high value (e.g., a high temperature, highest humidity, etc.) actually sensed by one or more sensors associated with the space over a time period. In some instances, the performance indicator can include a flag or other indicator configured to readily convey whether the performance indicator (e.g., a highest temperature experienced in the space over a time period) is satisfactory (e.g., is less than a highest permissible temperature threshold).

Conversely, in some embodiments, the out of performance range performance indicator can be a numerical value or other type of indicator (e.g., a check mark, etc.) that indicates the space failed to satisfy a performance threshold for at least a portion of time during a time period. For instance, the out of performance indicator can quantify an extent of any deviation from a threshold and/or can quantify an amount of time (e.g., a percentage) of a time period that the space was operating outside of a desired range (e.g., outside of a desired humidity and/or temperature range, etc.). The quantification of the extent of any deviation from the threshold and/or an amount of time of the deviation (e.g., how long the space was operating outside of a desired range) can be beneficial, particularly in the manufacturing context e.g., pharmaceutical manufacturing where strict adherence to various thresholds (e.g., temperature, humidity, etc.) is required from a regulatory and/or product quality/safety perspective.

In some embodiments, the method 700 can include receiving, via the computing device such as those described herein (e.g., a BMS computing device), a selection of one or more levels within the spatial hierarchical model, as indicated at 710. For example, a selection of one or more levels in a spatial hierarchal model can thereby result in the automatic selection of any building equipment which is mapped to various selected levels with the spatial hierarchical model. For example, selection of an individual room (e.g., a conference room) can automatically cause the corresponding selection and display of any building equipment in the individual room. Similarly, selection of the individual room (or other type of space in the spatial hierarchy model) can automatically cause display of detailed information (e.g., a priority of the individual room, etc.) and/or display of the aggregated performance indicator via the display. For instance, an indication of a respective location of the selected one or more levels within the spatial hierarchical model can be displayed responsive to receipt of the selection of the indication of the one or more levels within the displayed spatial hierarchical model. That is, responsive to receipt of the selection at 710, the method 700 can include the display of various information associated with the selected one or more levels. For instance, the method 700 can include displaying an aggregated performance indicator for the one or more levels within the spatial hierarchical model, as indicated at 712. As mentioned, the aggregated performance indicator is based on actual building equipment performance data of building equipment that is mapped to the one or more levels within the spatial hierarchical model. However, other information associated with the selected space can be displayed. For instance, in some embodiments, additional details such as a space usage type, area, occupancy, and/or a priority of the selected space can be displayed. For example, a space usage type, area, occupancy, and a priority of the selected space can be displayed in response to selection of a space, in some embodiments. In some embodiments, the method 700 can include concurrently displaying (e.g., via the same display of an individual computing device) each of: i) the summary of each of the elements in the spatial hierarchy; ii) the indication of a respective location of the selected one or more levels within the spatial hierarchical model; and iii) the priority, the space type, the occupancy state, or any combination thereof associated with the selected one or more levels within the spatial hierarchical model.

In some embodiments, additional information associated with one or more different spaces (other than a selected space) can be displayed. For instance, additional information including an aggregated performance indicator, a space usage type, an area, an occupancy, and/or a priority of a different space that is located above or below the selected space in the spatial hierarchical model can be displayed in addition to (e.g., concurrently with) various information (e.g., an aggregated performance indicator, a space usage type, an area, an occupancy, and/or a priority) associated with the selected space. Displaying the information associated with a selected space and additional information (e.g., with another space located below or above the selected space in the spatial hierarchical model can promote aspects herein. For instance, displaying respective aggregated performance indicators of the selected space (e.g., a zone) along with any spaces (e.g., one or more rooms within the selected zone) below the selected space (e.g., the depend from the selected space) can permit an operator or other individual to readily ascertain whether or not each of the spaces have a corresponding aggregated performance indicator that is suitable (e.g., is above a performance threshold). For example, while an aggregated performance indicator of a particular zone may be suitable (e.g., is above a performance threshold) it may be desirable to ensure that each room with the zone also has an aggregated performance indicator that is suitable e.g., to ensure that each room satisfies a performance threshold. As an example, while a performance indicator (e.g., “74”) may be suitable (e.g., is above a performance threshold of “60”), one or more rooms within the zone may have a corresponding aggregated performance indicator (e.g., “58”) that is below the performance threshold despite other rooms having aggregated performance thresholds (e.g., “82”, “95”, etc.) that are above the performance threshold. In such instances, an issue can be determined for the zone (e.g., for the room within the zone that has an aggregated performance indicator that is below the threshold, despite this room not being initially or directly selected). As such, the approaches herein can readily identify and remediate building issues (e.g., building equipment issues) and thus can promote aspects herein such as promoting compliance with regulatory and/or manufacturing guidelines (e.g., ensuring that a room in which a product is manufactured and/or stored is maintained at a suitable humidity, temperature, etc.) and/or achieve energy efficient goals in buildings.

In some embodiments, the method 700 comprises predicting occurrences of building equipment issues (e.g., failures) based at least in part on the spatial hierarchical model. For instance, a building equipment issue can be predicted based on comparison of aggregated performance indicator of a selected space in a spatial hierarchical model to a corresponding threshold or range. For example, an aggregated performance indicator that is indicative of the performance indicators of a plurality of building equipment mapped to a selected space can be compared to a corresponding threshold or range to predict a likelihood of one or more of the building equipment mapped to the building equipment experiencing an issue (e.g., a current issue or a future issue). For example, the prediction of the building equipment issue can be based on an extent of any deviation of the aggregated performance indicator from a threshold and/or a duration of time that the aggregated performance indicator deviated from the threshold. A larger deviation from the threshold and/or a longer duration of deviation from the threshold can be indicative of a building equipment issue (e.g., a current or high likelihood of occurrence of a future building equipment issue). Hence, the system herein can readily identify building equipment issues based at least in part on the spatial hierarchy model and one or more aggregated performance indicators associated with spaces in the spatial hierarchy model.

In some embodiments, the method 700 includes initiating a remediation of the predicted building equipment issue (e.g., a predicted based on the aggregated performance indicator of a space). For example, the method 700 can include initiating a remediation action to remediate a current building equipment issue and/or to remediate a predicted (future) building equipment issue prior to an actual occurrence of the predicted building equipment issue. In some embodiments, the method 700 can include displaying a visual representation of a status of the remediation action. For instance, the via a graphical user interface such as those described herein. Thus, the systems, devices, and methods herein can permit identification of remediation actions based on actual (real-time information) and can provide visual representations of actual (real-time) information indicative of a status of on-going remediations, thereby providing site managers with an enhanced wholistic vantage of various aspects pertaining to building management including the proactive remediation of predicted future issues with building equipment. For instance, in some embodiments, the methods herein can display a visual representation of a total quantity and/or type of completed remediation actions, display a visual representation of a total quantity and/or type of pending (yet to be completed) remediation actions, or both. In some embodiments, the visual representations of the status of the remediation action can be specific to the site, specific to a space within a spatial hierarchy model, specific to one or more operators associated with the site, or any combination thereof.

In some embodiments, the systems and methods herein can be configured to generate and display, via the computing devices described herein, a summary or report indicative various information associated with a spatial hierarchy model. For instance, the method 700 can include displaying a summary of elements in the spatial hierarchy such as summary of spaces (e.g., counts of various buildings, floors, zones, rooms) and/or and summary of building equipment (e.g., counts of all building equipment mapped to one or more spaces within the spatial hierarchy model). Display of the summary or report summarizing aspects associated with spatial hierarchy models can promote aspects herein such as a permitting an operator or supervisor to readily quantify in real-time various information or aspects associated with the spatial hierarchy models.

Aspects of the illustrative methods herein can be performed with or via one or more of the components described herein. For instance, the illustrative methods herein can be performed in conjunction with or by at least a computing device (e.g., computing device 200), among other possible components.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for spatial hierarchical model creation, display, and determination of aggregated performance indicators based on the spatial hierarchical model, the method comprising:
receiving, by a computing device of a building management system, spatial hierarchy data defining a spatial hierarchical model of a plurality of levels of spaces in a building and one or more building control assets disposed in the plurality of levels of spaces;
storing the spatial hierarchical model;
displaying, via a user interface, a visual representation of the spatial hierarchical model;
mapping building equipment within the building to one or levels of spaces within the spatial hierarchical model;
receiving, via the computing device, a selection of one or more spaces within the spatial hierarchical model; and
responsive to receipt of the selection, displaying an aggregated performance indicator for the one or more spaces within the spatial hierarchical model, wherein the aggregated performance indicator is based on actual building equipment performance data of building equipment that is mapped to the one or more spaces within the spatial hierarchical model;
wherein the spatial hierarchal model provides spatial context to a plurality of building control assets disposed within a plurality of hierarchical levels of spaces in the spatial hierarchical model.

2. The method of claim 1, further comprising: receiving, via the user interface, modifications to the spatial hierarchical model; receiving, via the user interface, modifications to the mapped building equipment; or both.

3. The method of claim 1, further comprising:
updating the stored spatial hierarchy data based on the received modifications; and
displaying, via the user interface, a visual representation of the spatial hierarchical model.

4. The method of claim 1, wherein the spaces comprise at least two of: a tower, a floor, a zone, and a room.

5. The method of claim 1, further comprising:
receiving building equipment system data associated with specific spaces in the spatial hierarchical model; and
storing the building equipment system data in association with the corresponding spaces to which the building equipment system data is mapped.

6. The method of claim 1, wherein the user interface comprises controls for adding, copying, pasting, moving, and deleting elements of the spatial hierarchical model.

7. The method of claim 1, further comprising receiving, via the user interface, detailed information for a selected space, the detailed information including at least one of: space type, description, space usage type, area, occupancy, and priority.

8. The method of claim 1, further comprising generating the aggregated performance indicator for one or more spaces within the spatial hierarchical model.

9. The method of claim 8, wherein the aggregated performance indicator includes an in-range performance indicator of the one or more spaces for a time period, an out-of-range performance indicator of the one or more spaces for the time period, or both.

10. The method of claim 1, further comprising generating the aggregated performance indicator for an individual space within the spatial hierarchical model.

11. The method of claim 1, further comprising predicting future occurrences of building equipment issues based at least in part on the spatial hierarchical model.

12. The method of claim 11, further comprising initiating remediation of predicted building equipment issues prior to their actual occurrence.

13. The method of claim 1, further comprising displaying a summary of elements in the spatial hierarchical model, the summary of elements including respective counts of buildings, floors, zones, rooms, building equipment, or any combination thereof.

14. The method of claim 1, wherein the spatial hierarchical model includes location information associated with the building, the location information comprising at least one of: country, region, and city.

15. A computing device for spatial hierarchical model creation, display, and determination of aggregated performance indicators based on the spatial hierarchical model, the computing device comprising:
a display;
a memory; and
a processor configured to execute executable non-transitory computer readable instructions stored in the memory to:
receive, via inputs provided to the display, spatial hierarchy data defining a spatial hierarchical model of a plurality of levels of spaces within a building and one or more building control assets disposed within the plurality of levels of spaces;
store the spatial hierarchical model in a database;
display, via the display, a visual representation of the spatial hierarchical model;
map building equipment within the building to one or more spaces within the spatial hierarchical model;
receive, via the display, a selection of one or more spaces within the spatial hierarchical model; and
responsive to receipt of the selection, display, via the display aggregated performance indicator for the one or more spaces within the spatial hierarchical model, wherein the aggregated performance indicator is based on actual building equipment performance data of building equipment that is mapped to the one or more spaces within the spatial hierarchical model;
wherein the spatial hierarchal model provides spatial context to a plurality of building control assets disposed in a plurality of hierarchical levels of spaces in the spatial hierarchical model.

16. The computing device of claim 15, wherein the processor is further configured to:
compare the aggregated performance indicator for the one or more spaces to a performance threshold; and
based on the comparison, initiate a remediation action associated with the building equipment mapped to the one or more spaces within the spatial hierarchical model.

17. A non-transitory, computer-readable medium including instructions that when executed by a processor cause the processor to:
receive, via inputs provided to a display, spatial hierarchy data defining a spatial hierarchical model of a plurality of spaces within levels of a building and one or more building control assets disposed in the plurality spaces;
determine a priority, a space type, an occupancy state, or any combination thereof associated with each of the one or more spaces in the spatial hierarchical model;
store the spatial hierarchical model in a database;
display, via the display, a visual representation of the spatial hierarchical model;
map, based on inputs provided to the display, building equipment within the building to the spaces within the spatial hierarchical model;
display, via the display, indications of each of the levels of the spaces in the spatial hierarchical model;
receive, via the display, a selection of an indication of one or more spaces within the displayed spatial hierarchical model; and
responsive to receipt of the selection, display, via the display:
a priority, a space type, an occupancy state, or any combination thereof associated with each of the one or more selected spaces in in the spatial hierarchy; and
aggregated performance indicator for the one or more spaces within the spatial hierarchical model, wherein the aggregated performance indicator is based on actual building equipment performance data of building equipment that is mapped to the one or more selected spaces within the spatial hierarchical model.

18. The medium of claim 17, further comprising displaying an indication of a respective location of the selected one or more spaces within the spatial hierarchical model responsive to receipt of the selection of the indication of the one or more spaces within the displayed spatial hierarchical model.

19. The medium of claim 18, further comprising displaying a summary of each of the elements in the spatial hierarchy, the summary including counts of buildings, floors, zones, rooms, and equipment in the spatial hierarchical model.

20. The medium of claim 19, further comprising concurrently displaying at least:
the summary of each of the elements in the spatial hierarchy;
the indication of a respective location of the selected one or more spaces within the spatial hierarchical model; and
the priority, the space type, the occupancy state, or any combination thereof associated with the selected one or more spaces within the spatial hierarchical model.
